(19) United States
(12) Patent Application Publication
(10) Pub. No.: US 2015/0220826 A1
(43) Pub. Date: Aug. 6, 2015

(54) PRINTER AND PRINTING SYSTEM

(71) Applicant: Seiko Epson Corporation, Tokyo (JP)

(72) Inventor: Keigo Mori, Matsumoto-shi (JP)

(73) Assignee: SEIKO EPSON CORPORATION, Tokyo (JP)

(21) Appl. No.: 14/615,024

(22) Filed: Feb. 5, 2015

(30) Foreign Application Priority Data
Feb. 5, 2014 (JP) 2014-020072

(51) Int. Cl. G06K 15/00; G06F 3/12

(52) U.S. Cl. CPC G06K 15/4095; G06F 3/1222; G06F 3/1293

(57) ABSTRACT

A printing system 1 has a terminal 11 and a printer 10. The terminal 11 has a terminal control unit 30 that sends an authentication request, and after authentication succeeds based on the authentication request, sends a request for a log file LF (data including a log). The printer 10 has a print unit 21 that prints; a second communication interface 24 that communicates with the terminal 11; and a control unit 20 that performs authentication based on an authentication request by a function of SSH server software SW1, and when a log file request is received from the terminal 11 after authentication based on the authentication request succeeds, sends a log file LF related to the print unit 21.

Priority is claimed under 35 U.S.C. §119 to Japanese Application no. 2014-020072 filed on Feb. 5, 2014 which is hereby incorporated by reference in their entirety.

### BACKGROUND

1. Technical Field

The present disclosure relates to a printer and to a printing system including the printer.

2. Related Art

Systems that have a print control device (host device) and a printer that prints as controlled by the print control device are known from the literature. See, for example, JP-A-2011-136485. Such printers may also have a function for connecting to a network.

There is a need for such printers to be able to execute a specific process through a secure connection using the ability of the printer to connect to a network.

### SUMMARY

An objective of the present invention is to provide a printer and a printing system that enable executing a specific process on the printer through a secure connection using the ability of the printer to connect to a network.

A printer according to one aspect of the invention includes a print unit that prints; a communication unit that receives an authentication request through a network; and a control unit that runs server software to perform authentication based on an authentication request received by the communication unit.

Thus comprised, the printer can perform authentication by a function of the server software based on an authentication request from an external device connected to a network. As a result, after the external device is authenticated by the printer, the external device can execute specific processes on the printer through a secure connection.

Preferably, the printer also has a storage unit that stores log data including operating information of the print unit. When a request for transmission of log data is received by the communication unit after authentication is performed by the control unit and authentication is successful, the printer sends the log data by the communication unit.

Thus comprised, an external device connected to the network can request authentication by the printer, and after authentication based on the authentication request succeeds, can acquire log data by communicating with the printer over the network. More specifically, the external device can control the printer to send log data over a secure connection.

Further preferably, the storage unit stores a settings file including settings information of the print unit; and when a request to edit the settings file is received by the communication unit after authentication is performed by the control unit and authentication is successful, the control unit edits the settings file.

Thus comprised, an external device connected to the network can request authentication by the printer, and after authentication based on the authentication request succeeds, can control the printer to edit a settings file. More specifically, the external device can control the printer to edit the settings file through a secure connection.

In another aspect of the invention, the storage unit stores a control program that controls the print unit; and when a request to change the control program is received by the communication unit after authentication is performed by the control unit and authentication is successful, the control unit changes the control program.

Thus comprised, an external device connected to the network can request authentication by the printer, and after authentication based on the authentication request succeeds, can control the printer to change the control program. More specifically, the external device can control the printer to change the control program through a secure connection.

Further preferably, the server software executes processes according to a Secure Shell (SSH) protocol.

Thus comprised, by using the external device as a SSH client of the printer, which is a SSH server, processes can be executed by the external device on the printer through a secure connection.

Another aspect of the invention is a printing system including: a terminal that sends an authentication request; and a printer including a print unit that prints, a communication unit that receives an authentication request sent by the terminal through a network, and a control unit that runs server software to perform authentication based on an authentication request received by the communication unit.

Thus comprised, the printer can perform authentication by a function of the server software based on an authentication request from a terminal device connected to a network. As a result, after the terminal device is authenticated by the printer, the terminal device can execute specific processes on the printer through a secure connection.

In a printing system according to another aspect of the invention, the printer has a storage unit that stores log data including operating information of the print unit; the terminal sends a request for transmission of log data; and when a request sent by the terminal for transmission of log data is received by the communication unit after authentication is performed by the control unit and authentication is successful, the control unit of the printer sends the log data by the communication unit.

Thus comprised, a terminal connected to the network can request authentication by the printer, and after authentication based on the authentication request succeeds, can acquire log data by communicating with the printer over the network. More specifically, the terminal can control the printer to send log data over a secure connection.

In a printing system according to another aspect of the invention, the storage unit of the printer stores a settings file including settings information of the print unit; the terminal sends a request to edit the settings file; and when a request to edit the settings file sent by the terminal is received by the communication unit after authentication is performed and authentication is successful, the control unit of the printer edits the settings file.

Thus comprised, a terminal device connected to the network can request authentication by the printer, and after authentication based on the authentication request succeeds, can control the printer to edit a settings file. More specifically, the terminal device can control the printer to edit the settings file through a secure connection.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the functional configuration of a printing system.

FIG. 2 is a flow chart showing the operation of a terminal and a printer.

### DESCRIPTION OF EMBODIMENTS

A preferred embodiment of the present invention is described below with reference to the accompanying figures.

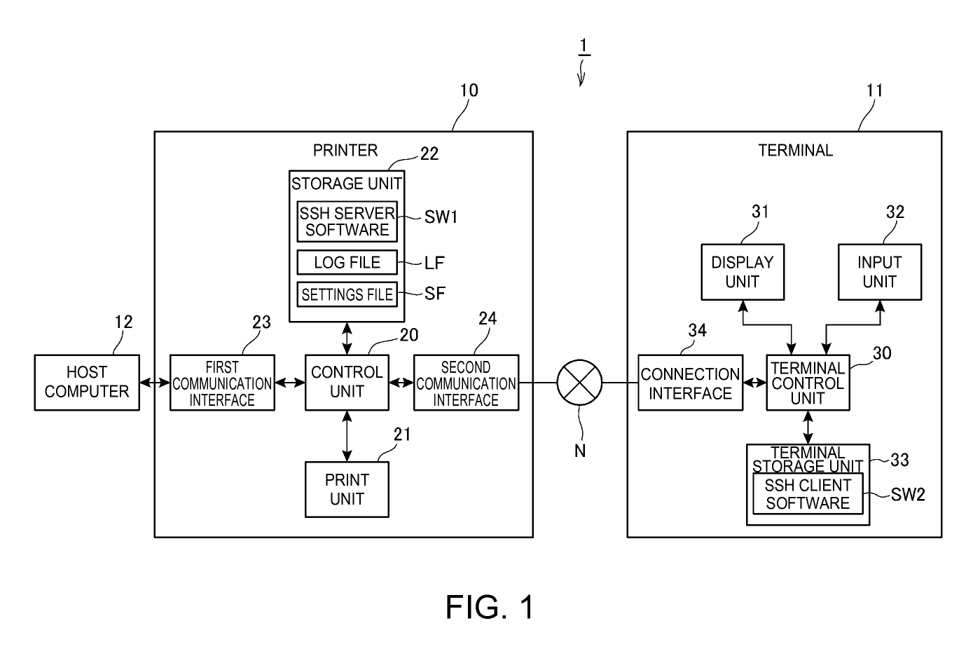

FIG. 1 is a block diagram showing the functional configuration of a printing system 1 according to a preferred embodiment of the invention.

As shown in FIG. 1, the printing system 1 includes a printer 10, and a terminal 11 (external device) that can connect to the printer 10 through a network N such as the Internet.

As shown in FIG. 1, the printer 10 has a control unit 20, print unit 21, storage unit 22, first communication interface 23, and second communication interface 24 (communication unit).

The control unit 20 includes a CPU, ROM, RAM, and other peripheral circuits. The control unit 20 controls the printer 10 by, for example, the CPU reading and running firmware or other control program.

The print unit 21 includes a printhead and a conveyance mechanism for conveying the print medium, and prints on the print medium as controlled by the control unit 20.

The storage unit 22 has an EEPROM or other nonvolatile memory, for example, and stores data.

The first communication interface 23 communicates according to a specific communication protocol with the host computer 12 as controlled by the control unit 20. The communication standard may be a serial communication standard such as USB or RS232-C, or an Ethernet (T) compatible communication standard.

The second communication interface 24 communicates with the terminal 11 according to a specific communication protocol through the network N as controlled by the control unit 20.

The printer 10 prints as controlled by the host computer 12.

More specifically, a printer driver is installed on the host computer 12. The host computer 12 starts controlling the printer 10 in response to a request from a specific application. When there is a request for printing by the printer 10 from a specific application, the host computer 12 generates a control command causing the printer 10 to print by a function of the printer driver. Next, the host computer 12 sends the control command to the printer 10. When the control command is received, the control unit 20 of the printer 10 controls the print unit 21 to print based on the received control command.

The control unit 20 of the printer 10 has a function for storing a log by writing log information (operating information) to a log file LF (log data) stored in a storage unit 22.

This log information is information such as described below. The log information is information relating information indicating operations performed on the printer 10 to information indicating when (the date and time) the operation was performed. Operations on the printer 10 include, for example, operations opening and closing a cover of the printer 10, operations instructing automatically feeding the print medium, and operations turning the power on or off. Sensors and mechanisms that detect these operations are disposed to the printer 10. The printer 10 also has a timekeeping means such as a real-time clock (RTC), and the control unit 20 gets the current time based on output from the RTC.

When the control unit 20 detects by a function of firmware or a program that a predetermined specific operation was performed, it writes information representing the performed operation and information representing the current time in a log file LF. The log information may also include information identifying a process executed by the printer 10 to time information indicating when the process was executed. This process may include, for example, a printing process or a flushing operation that is performed if the printer 10 is an inkjet printer. The log information may also include information identifying an error that occurred on the printer 10 with information indicating when the error occurred. The error may be, for example, an error related to the printhead, such as an abnormal temperature in the printhead, or an error in the conveyance mechanism or the cutter mechanism. The log information is not so limited, and is illustrated here for example only.

The storage unit 22 of the printer 10 stores a settings file SF.

The settings file SF is a file recording information (referred to below as settings information) related to the print density, printing speed, paper width, or other printer 10 setting.

To control the print unit 21, the control unit 20 of the printer 10 references the settings information recorded in the settings file SF, and controls the print unit 21 based on the settings information.

The terminal 11 in this embodiment of the invention may be a desktop computer, a notebook computer, a tablet terminal, or a cell phone, but the terminal 11 is not so limited.

As shown in FIG. 1, the terminal 11 includes a control unit 20, a display unit 31, a input unit 32, a terminal storage unit 33, and a connection interface 34.

The control unit 20 includes a CPU, ROM, RAM, and other peripheral circuits, and controls the terminal 11.

The display unit 31 displays images on an LCD panel or other display panel as controlled by the terminal control unit 30.

The input unit 32 is connected to an input means such as a keyboard, mouse, switch, or button, detects input to the input means, and outputs to the terminal control unit 30.

The terminal storage unit 33 may be an EEPROM, hard disk drive, or other type of nonvolatile storage device, and stores data.

The connection interface 34 communicates with the printer 10 according to a specific communication protocol through the network N as controlled by the terminal control unit 30.

SSH server software SW1 is installed on the printer 10. The SSH server software SW1 may be OpenSSH, for example. By running the SSH server software SW1, the printer 10 functions as a SSH server to the terminal 11. SSH (Secure Shell) is a protocol enabling secure remote control of a SSH server by an SSH client based on server authentication and user authentication technologies.

Remote control as used herein means sending encrypted commands to the printer 10, which is a SSH server, from the terminal 11, which is a SSH client, for executing a process based on the transmitted commands on the printer 10.

SSH client software SW2 is installed on the terminal 11. The SSH server software SW2 may also be OpenSSH, for example. By running the SSH server software SW2, the terminal 11 functions as a SSH client to the printer 10.

As described above, the storage unit 22 of the printer 10 stores a log file LF.

In this embodiment of the invention, the terminal 11 can acquire the log file LF from the printer 10 by communicating over the network N as a result of the printer 10 and the terminal 11 executing the process described below.

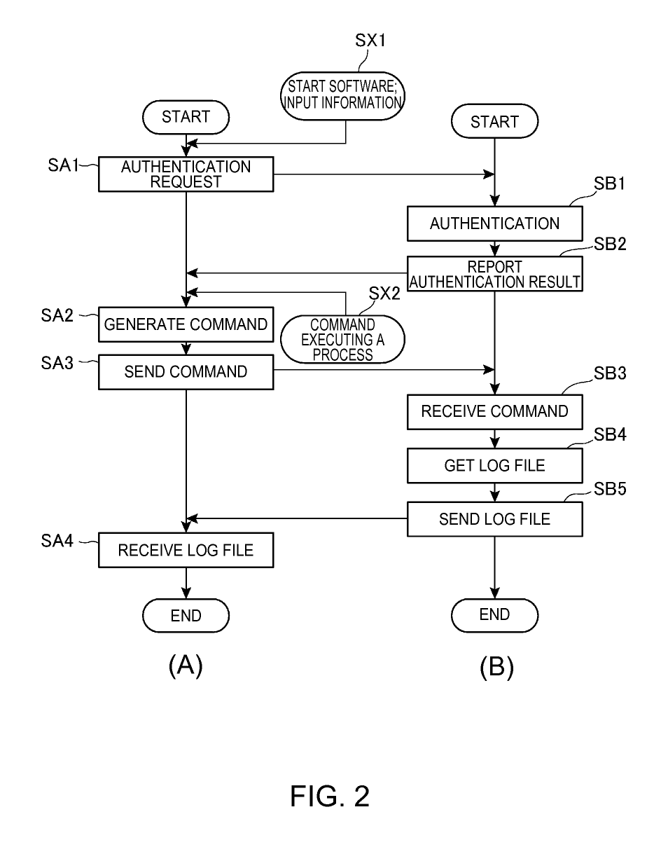

FIG. 2 is a flow chart showing the operation of the printer 10 and the terminal 11, column (A) showing the operation of the terminal 11 and (B) showing the operation of the printer 10.

The SSH server software SW1 of the printer 10 is already running when the operation shown in the flow chart in FIG. 2 starts.

The user then operates the mouse, keyboard, or other input device connected to the terminal 11, and starts the SSH client software SW2. Next, the user input the information used to log in to the printer 10 to the user interface provided by the SSH client software SW2. The input information includes, for example, the address of the printer 10 to access, the port, what communication protocol to use, the authentication method (a password input method in this example), and the ID and password used for authentication.

As shown in FIG. 2 (A), the user first inputs information to the user interface and confirms input (step SX1), and the terminal control unit 30 of the terminal 11 sends data including the ID and password according to the SSH protocol to the terminal 11 and requests verification (step SA1). Data communicated between the SSH server and the SSH client is encrypted according to the SSH protocol using a specific encryption method.

As shown in FIG. 2 (B), the control unit 20 of the printer 10 then performs authentication based on the received data according to the SSH protocol (step SB1). The data required for authentication (such as the ID and password combination) is previously registered in the printer 10. As may be required, authentication in step SB1 may also include the printer 10 and terminal 11 communicating for server authentication and user authentication according to the SSH protocol.

After authentication, the control unit 20 of the printer 10 reports the result of authentication to the terminal 11 (step SB2). In this example authentication is successful in step SB1, and the control unit 20 reports authentication success to the terminal 11.

After authentication, the user can control the printer 10 to execute a specific process. This control is accomplished by inputting and verifying the commands and associated parameters controlling the process to be executed to a user interface provided by the SSH client software SW2 or other application.

When the user instructs and confirms requesting the printer 10 to send the log file LF to the terminal 11 (step SX2), the control unit 30 of the terminal 11 generates a command in a specific format requesting transmission of the log file LF (step SA2).

Next, the terminal control unit 30 sends the generated commands to the printer 10 by SSH protocol (step SA3).

The control unit 20 of the printer 10 then receives the commands (step SB3).

Next, the control unit 20 gets the log file LF stored by the storage unit 22 based on the received command (step SB4).

Next, the control unit 20 generates data in a specific format including the log file LF, and sends the data according to the SSH protocol to the terminal 11 (step SB5).

The control unit 30 of the terminal 11 then receives the data (step SA4). The log file LF contained in the received data is then stored to a specific storage area.

The terminal 11 can thus acquire a log file LF from the printer 10 by communicating over a network N. To acquire the log file LF, the user must simply have access to a terminal 11 that can function as a SSH client, and does not need to go to where the printer 10 is. The user can therefore use the terminal 11 to easily acquire a log from a printer 10 storing the log file LF.

Note that by communicating over a network N, the terminal 11 can also control the printer 10 to execute processes other than sending the log file LF after authentication, including editing the settings file SF and modifying a control program stored by the printer 10 in firmware, for example.

To edit the settings file SF, the control unit 30 of the terminal 11 generates commands appropriate to the user instruction, and sends the commands by SSH protocol to the printer 10. The control unit 20 of the printer 10 then edits the settings file SF based on the received commands.

To modify the control program, the control unit 30 of the terminal 11 generates commands appropriate to the user instruction, and sends the commands by SSH protocol to the printer 10. The control unit 20 of the printer 10 then edits the control program based on the received commands.

As described above, a printer 10 according to this embodiment of the invention has a print unit 21 that prints, a second communication interface 24 (communication unit) that receives authentication requests through a network N, and a control unit 20 that runs SSH server software SW1 (server software) that performs authentication based on the authentication request received by the second communication interface 24.

Thus comprised, the printer 10 can perform authentication by a function of the SSH server software SW1 based on an authentication request from a terminal 11 connected to a network N. As a result, by installing SSH client software SW2 on the terminal 11 and controlling the terminal 11 to function as a SSH client to the printer 10, the terminal 11 can execute specific processes on the printer 10 through a secure connection after authentication by the printer 10.

When a transmission request for the log file LF (log data) is received after authentication based on the authentication request succeeds, the control unit of the printer 10 sends the log file LF to the second communication interface 24.

Thus comprised, a terminal 11 connected to the network can send an authentication request to the printer 10, and by communicating over the network N after authentication based on the authentication request succeeds, can acquire the log file LF data.

After successful authentication based on the authentication request in this embodiment, the control unit 30 of the terminal 11 sends a command to edit the settings file SF in which information related to settings of the print unit 21 are recorded. When a command to edit the settings file SF is received after successful authentication based on the authentication request, the control unit 20 of the printer 10 edits the settings file SF.

Thus comprised, the settings file SF of the printer 10 can be edited over the network N from the terminal 11, and editing the settings file SF is simplified.

After successful authentication based on the authentication request in this embodiment, the control unit 30 of the terminal 11 sends a command to edit the control program related to controlling the print unit 21. When a command to edit the control program is received after successful authentication based on the authentication request, the control unit 20 of the printer 10 edits the control program.

Thus comprised, the control program of the printer 10 can be edited over the network N from the terminal 11, and editing the control program is simplified.

The invention is described above with reference to a preferred embodiment thereof, but the invention is not limited thereto and can be modified and adapted in many ways without departing from the scope of the accompanying claims.

The function blocks shown in FIG. 1 can be achieved by the cooperation of hardware and software, and do not suggest a specific hardware configuration. The printer 10 may also execute processes by running a program stored in an externally connected storage medium.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

What is claimed is:

1. A printer comprising:
a print unit that prints;
a communication unit that receives an authentication request through a network; and
a control unit that runs server software to perform authentication based on the authentication request received by the communication unit.

2. The printer described in claim 1, further comprising:
a storage unit that stores log data including operating information of the print unit;
wherein when a request for transmission of log data is received by the communication unit after authentication is performed by the control unit and authentication is successful, the printer sends the log data by the communication unit.

3. The printer described in claim 2, wherein:
the storage unit stores a settings file including settings information of the print unit; and
when a request to edit the settings file is received by the communication unit after authentication is performed by the control unit and authentication is successful, the control unit edits the settings file.

4. The printer described in claim 2, wherein:
the storage unit stores a control program that controls the print unit; and
when a request to change the control program is received by the communication unit after authentication is performed by the control unit and authentication is successful, the control unit changes the control program.

5. The printer described in claim 1, wherein:
the server software executes processes according to a Secure Shell (SSH) protocol.

6. A printing system comprising:
a terminal that sends an authentication request; and
a printer including a print unit that prints, a communication unit that receives an authentication request sent by the terminal through a network, and a control unit that runs server software to perform authentication based on the authentication request received by the communication unit.

7. The printing system described in claim 6, wherein:
the printer has a storage unit that stores log data including operating information of the print unit;
the terminal sends a request for transmission of log data; and
when a request sent by the terminal for transmission of log data is received by the communication unit after authentication is performed by the control unit and authentication is successful, the control unit of the printer sends the log data by the communication unit.

8. The printing system described in claim 7, wherein:
the storage unit of the printer stores a settings file including settings information of the print unit;
the terminal sends a request to edit the settings file; and
when a request to edit the settings file sent by the terminal is received by the communication unit after authentication is performed and authentication is successful, the control unit of the printer edits the settings file.

9. The printing system described in claim 7, wherein:
the storage unit of the printer stores a control program that controls the print unit; and
when a request to change the control program is received by the communication unit after authentication is performed by the control unit and authentication is successful, the control unit changes the control program.

10. The printing system described in claim 6, wherein:
the server software executes processes according to a Secure Shell (SSH) protocol.
